(19) United States
(12) Patent Application Publication
(10) Pub. No.: US 2010/0180329 A1
(43) Pub. Date: Jul. 15, 2010

(54) Authenticated Identity Propagation and Translation within a Multiple Computing Unit Environment

(75) Inventors: Richard Henry Guski, Red Hook, NY (US); Deborah Mapes, Port Ewen, NY (US); William O'Donnell, Fitchburg, WI (US); Ira Steven Ringle, Saugerties, NY (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 12/351,291

(22) Filed: Jan. 9, 2009

(51) Int. Cl. H04L 9/00

(52) U.S. Cl. 726/8

(57) ABSTRACT

An authenticated identity propagation and translation technique is provided in a transaction processing environment including distributed and mainframe computing components. Identified and authenticated user identification and authentication information is forwarded in association with transaction requests from a distributed component to a mainframe component, facilitating the selection of the appropriate mainframe user identity with which to execute the mainframe portion of the transaction, and creating the appropriate runtime security context. The forwarded user identification and authentication information contains a plurality of sections with identifying information about an authenticated client end-user identity as known at the initial authentication component and a mask specifying a subset of the sections. The mainframe component generates a hash from the subset of sections specified by the mask and uses that hash as a lookup key to determine whether a local authenticated runtime security context already exists in a local cache for the client end-user initiating the transaction request.

### BACKGROUND OF THE INVENTION

1. Field of the Invention

The present invention relates in general to identification and authentication within a multi-computing unit environment, and more particularly, to a global, authenticated identity translation technique within such a multi-computing unit environment.

2. Description of the Related Art

Often an integrated set of multiple software products constitute an environment that is a solution to a customer business problem(s). End users of such a solution can be known by different identities in multiple security domains that participate in the solution. U.S. Patent Application Publication 2006/0288228, incorporated herein by reference, describes a feature known as z/OS Identity Propagation, which provides the foundation for consistent auditing, access control, and user management in such solution environments. Individual users can have one or more “differentiating factors” that can cause the same human or programmatic user to be treated as a different identity when such differentiating factors are or are not present. An example of such a differentiating factor might be the Multi-level Security “Security Label” that the user entered (signed on to) the data processing environment with. Another example might be the physical location (port of entry) via which the user is accessing the environment. Advanced identity propagation implementations will allow customers to include their own differentiating factors, and to customize their identity propagation implementations to include them.

The general problem area of this which this invention is directed is that details of each user's identity, as administratively defined within the security domain plus any or all differentiating factors, must be included in any product caches of propagated identities, where by “caches” is meant the temporary storage areas within various products that propagated identities propagate to. For example, as described in the aforementioned patent application publication, IBM WebSphere Application Server (WAS) may “propagate” a run-time representation of an authenticated user identity on to the IBM Customer Information Control System (CICS), or to the IBM Information Management System (IMS), where the run-time representation (which we call a SAF-RACF Accessor Environment Element or “ACEE”) finds its way into a data cache local to those products. Such caches of ACEEs (reflecting multiple users concurrently) must be indexed by a “key” that is derived, usually by a hash function, from the identity determining specific parts of each individual ACEE.

The specific problem that the present invention addresses is that when customers exploit the capability of Identity Propagation to include data of their own choosing, there is no way for the involved program products to know that such customer-provided information is or is not to be considered user-differentiating information and therefore to be included or not to be included with the other user-differentiating parts of the identity in developing the hash index key.

### SUMMARY OF THE INVENTION

A core idea underlying our invention is to provide a way for identity-differentiating information, including but not restricted to that which a customer might add to the identity information that is propagated by z/OS Identity Propagation (ID Prop), to be specifically indicated as being a necessary part of the hashable portion of the propagated identity information, and for this “hashable indicator information” to be propagated along with the rest of the identity information. The advantage and novelty of our invention is that this “hashable indicator information” is thus available to receivers of propagated identities, such as CICS and IMS, so that their cache keys (previously described) can be correctly constructed dynamically according to the particular customer dictated situation.

The identity information that propagates includes various “sections” that include but are not limited to for example a section containing a user's identity in X.500 form (a well known standard), and a section that contains additional information provided by the customer. These and other identity information sections that are present are aligned and in synchrony with a bit mask, which we refer to as the Identity Propagation “hash mask”. There is a bit in the hash mask for each individual section in the identity information. By default, certain of these bits are turned on, for example the section that contains the user's identity in X.500 form is on by default. Since additional customer information is optional, by default the bit associated with additional customer information is off. When a customer chooses to exploit the capability to include additional information within the ID Prop identity information, the customer will now also have the option to include such information in the hashable information by turning on the appropriate bit in the hash mask.

More particularly, the present invention contemplates an authenticated identity propagation and translation method and system for use in a transaction processing environment containing an initial authentication component (e.g., a distributed component) and a subsequent processing component (e.g., a mainframe component). In accordance with one embodiment of the invention, the initial authentication component, responsive to a transaction request initiated by an authenticated client end-user requiring further transaction processing at the subsequent processing component, generates a further transaction request together with distributed security information and transmits the further transaction request and the distributed security information to the subsequent processing component (possibly via different transmission routes, as described below). The distributed security information contains a plurality of sections with identifying information about an authenticated client end-user identity as known at the initial authentication component and a mask specifying a subset of the sections.

The subsequent processing component, responsive to receiving the further transaction request from the initial authentication component, generates a lookup key from the subset of the sections of the distributed security information specified by the mask, preferably from a hash of the subset, and uses the generated lookup key to determine whether a local authenticated runtime security context already exists in a local cache for the client end-user initiating the transaction request.

Preferably, if a local authenticated runtime security context already exists for the client end-user initiating the transaction request, the existing local authenticated runtime security context is employed in executing the further transaction request; otherwise, the authenticated client end-user identity of the client end-user at the initial authentication component is mapped to a local identity employing the distributed security information and a local authenticated runtime security context is created representative of the local mainframe identity and the authenticated client end-user identity for execution of the further transaction request.

Embodiments of the invention relate to the initial authentication component as described above and to the subsequent processing component as described above, as well as the combination of the two.

The method and system of the present invention are preferably implemented using one or more hardware machines in combination with computer software running on those machines. The software portion of such an implementation contains logic in the form of a computer-readable program for causing a computer (i.e., a hardware machine) to perform the method steps of the invention. The computer-readable program may be embodied as a computer program product stored on a tangible computer-usable medium comprising one or more volumes using semiconductor, magnetic, optical or other storage technology.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a multi-component transaction processing environment illustrating a problem addressed by one or more aspects of the present invention;

FIG. 2 depicts one example of one possible solution to the problem illustrated by FIG. 1;

FIG. 3 shows one embodiment of a transaction processing environment incorporating the present invention;

FIG. 4 shows an alternative embodiment of a transaction processing environment incorporating the present invention;

FIG. 5 shows the steps performed by the initial authentication component of the transaction processing environment of FIG. 3;

FIG. 6 shows the steps performed by the subsequent processing component of the transaction processing environment of FIG. 3;

FIG. 7A shows the distributed security information transmitted from the initial authentication component to the subsequent processing component of the transaction processing environment shown in FIG. 3; and

FIG. 7B shows the generation of a lookup key by the subsequent processing component shown in FIG. 3.

### BEST MODE FOR CARRYING OUT THE INVENTION

In accordance with one or more aspects of the present invention, a method of propagating client end-user identification and authentication information from a distributed component of a multi-component transaction processing environment to a mainframe component of such an environment is provided. The method facilitates client end-user identification and authentication (signing on) within a distributed component of a multi-component (distributed and mainframe) transaction processing computing environment employing disparate user registries; and includes dynamically translating an authenticated user identity as known on a distributed component of said environment into an associated local identity on at least one mainframe component of the transaction processing computing environment.

A specific example of a multi-component environment wherein components work together cooperatively to form a larger system is the IBM Hypertext Transfer Protocol (HTTP) and Web services processing environment, as often implemented by IBM customers using IBM mainframe computers, such as the IBM z9-109 family of computing machines or their successors. This environment typically includes IBM's WebSphere Application Server (WAS) middleware platform software product working in conjunction with one or more of IBM's transaction processing products like IBM Customer Information Control System (CICS) and/or IBM Information Management System (IMS), IBM's relational database product IBM Database 2 (DB2), or the like.

The objective of this example of a multi-component environment is to provide a high performance transaction processing computing system or environment accessible to client end-users via Internet browsers (such as Microsoft Internet Explorer or Mozilla Firefox) using the HTTP networking protocol, or via other Web services. In this environment, IBM WebSphere Application Server (WAS) is the component in the environment that is directly communicating with the client end-user who is making the HTTP or Web services request. For discussion clarity, in this disclosure, we refer to the WAS component within this environment as the “distributed” component of the environment.

Typically, in order to fulfill the transaction request from the distributed client end-user, WAS must invoke the services of one or more other components in the environment such as CICS, IMS, DB2. These components typically execute on the z/OS operating system, which is often referred to as the IBM “mainframe” operating system platform. For this reason, and again for discussion clarity, these software products, along with other products that execute on the z/OS platform, are referred to herein as the “mainframe” components of the multi-component distributed transaction processing environment.

In such an environment, the IBM transaction processing, messaging, and database components typically are executing within an IBM mainframe computer which uses the IBM Resource Access Control Facility (RACF), including RACF's user registry, as its “security engine”. WAS, on the other hand, may or may not be executing on the same IBM mainframe computer, since it could be executing on a different computer with a different security engine and user registry while interacting with the other components in the environment via authenticated and secure networking connections. In either case, the client end-user is identified and authenticated to WAS using a “distributed” security engine and user registry, such as Windows Active Directory, a product of Microsoft Corporation. The runtime security context that WAS uses for processing the WAS portion of the overall transaction request contains the identity of the user in its distributed form, and not the identity of the user as it would be represented within the RACF security engine and user registry. Further, the runtime security context that the mainframe transaction processing, messaging, and database components require for processing will need to represent the client end-user as a user identity in RACF form, which is typically different from the identity of the user in distributed form.

Sometimes, security engine function, including the registry of end users, may be common to some subset of the components of the multi-component environment but not all of them. For example, often platforms will have their own administrative tools that allow a system administrator to add, delete, or modify user identities in the end user registry. This means that the system administrator must learn and become proficient in several different tools, which handle identity management. Although the administrative aspects of the multi-component transaction processing environment are important, they are not the focus of this invention, as they are dealt with in acceptable fashion by multiple registry user provisioning strategies and products like IBM Tivoli Identity Manager and IBM Tivoli Directory Integrator. Instead, the problems that this invention addresses and therefore the focus of this invention involve the runtime security aspects of this multi-component environment.

The focus of the present invention is the environmental reality that some components and client end-users of the multi-component environment may be known in, and authenticated by, a distributed security engine and registry, while subsequently executing transactions (or causing them to be executed) within a mainframe component of the environment, which is executing under the security control of the mainframe security engine and user registry, for example IBM RACF.

More specifically, one problem addressed by the teachings of this invention is the flowing-through or “propagation” of a client end-user-identity that has been identified and authenticated in a distributed component (like WAS) of the multiple component transaction processing environment, to a mainframe component of the same environment, and appropriately translated to a customer selected mainframe user identity, for execution of the mainframe component of the overall transaction, without the need for the client end-user to have to re-authenticate or even be aware of his/or her mainframe user identity or that this process is in effect.

Further, today there is no logical mechanism in place, or available as a design option (because of performance and programming model restrictions) appropriate for the described multi-component transaction processing environment, to translate from the distributed runtime representation of the client end-user identity to the mainframe runtime representation of the user's identity, or to include the user's distributed identity in runtime audit records created by the mainframe (as described herein). Because of this, IBM customers typically have no choice but to configure WAS so as to cause the execution of the mainframe components, of all distributed transaction requests, under a single, essentially “hard-coded”, mainframe identity, thereby losing the potential for auditing and access control at the granularity of the identity of client end-user. This condition is recognized as a long standing goal within the industry for so called “end-to-end” auditing of transactions of distributed origin that process in such environments.

Thus, presented herein, in one aspect, is an authenticated identity propagation and translation method which includes: establishing an authenticated user identity responsive to an identification and authentication event within an environment comprising a component within the environment where user identification and authentication occurs based on the user's administratively assigned distributed identity and a subsequent component where further processing occurs based on the user's administratively assigned mainframe identity, the distributed component and the subsequent mainframe component employing disparate user registries with perhaps different user identity character strings representing the same physical client end-user; forwarding the identified and authenticated distributed identity from the distributed component to the mainframe component; and facilitating the translation of the authenticated user identity within the distributed component to a local user identity within the mainframe component, utilizing for example an existing mainframe user identity translation component such as IBM's Enterprise Identity Mapping (EIM), the technology of which is disclosed in U.S. Pat. No. 6,981,043, incorporated herein by reference, or, alternatively, the identity mapping function within the existing mainframe security engine RACF.

Aspects of the present invention advantageously support application runtime interoperation between disparate security registry services which employ different forms of user identification and authentication. In accordance with the authenticated identity propagation and translation technique disclosed herein, an exploiter of the function does not have to know which target system or systems a further request will be forwarded to in a multi-component transaction processing environment.

Further, using the present technique, user passwords exist only inside the protection offered by the security engine and user registry whereby a client end-user initially authenticates, which is the distributed component of the overall environment, thereby facilitating administration of the system and ease of use for the client end-user as the user need only identity and authenticate once to the entire transaction processing environment.

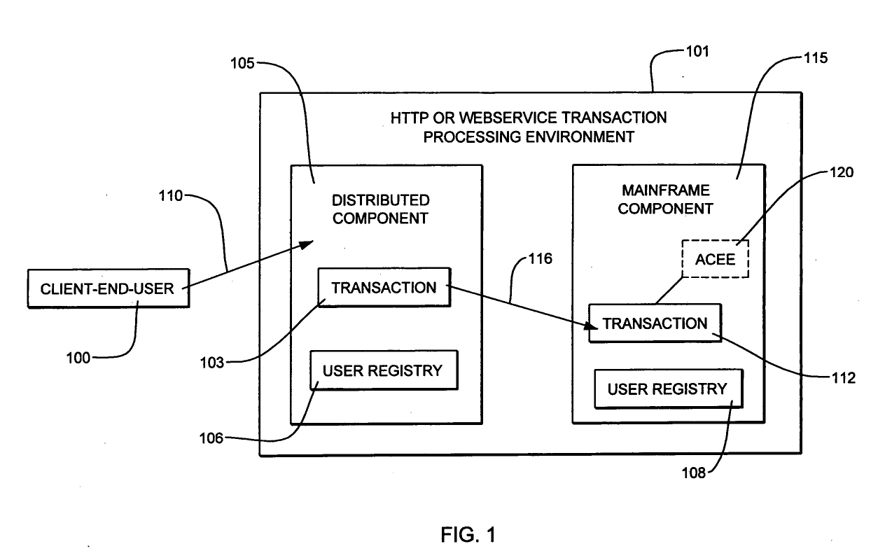

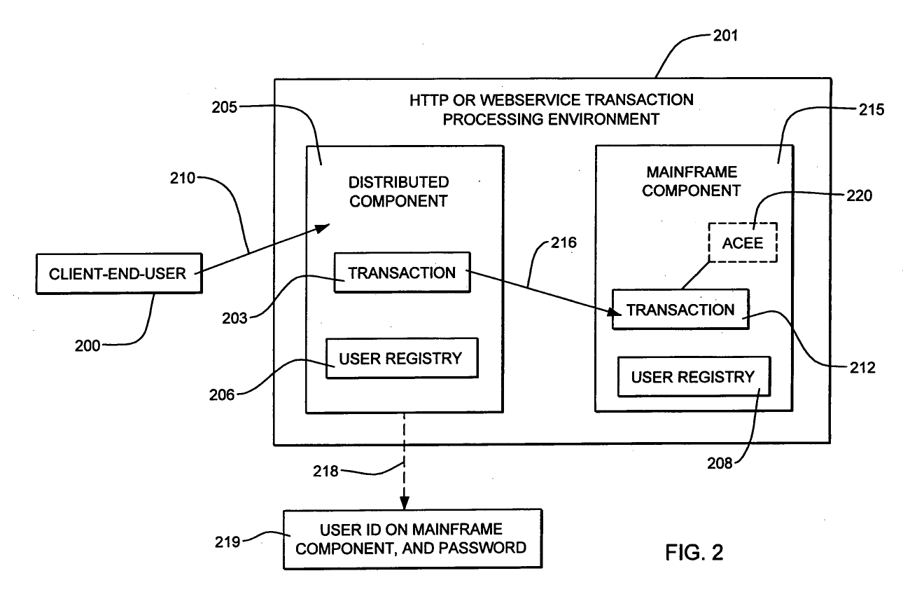

The problem addressed by the authenticated identity translation technique disclosed herein is explained more below with reference to FIGS. 1 and 2.

FIG. 1 depicts a multi-component transaction processing environment 101, including a distributed component 105 employing a local user registry 106, and a mainframe component 115 employing a local user registry 108.

In the example of FIG. 1, the distributed component and the mainframe component are assumed to be built on disparate platforms, with local user registries 106 and 108 being distinct. A user 100 is identified and authenticated 110 via, for example, Secure Sockets Layer (SSL) protocol, on the distributed component 105 of the multi-component transaction processing environment using a corresponding user identity from user registry 106. Once identified and authenticated, the user may request 110 a transaction or function 103, of the distributed component of the overall transaction processing environment that, as part of its processing, requests 116 another transaction or function 112 of the mainframe component 115 of the transaction processing environment. Typically, this transaction or function will need to execute using an identity known within the user registry of the mainframe component of the transaction processing environment. The problem is how to securely propagate the client end-user identity, known within the distributed component, to the mainframe component, and to establish an identified and authenticated client end-user runtime security context with the appropriate mainframe user identity.

Note that the purpose of the runtime-security context is to provide processing thread availability to the operating system and the application of the client end-user identity, as it is known on the mainframe, for resource access control and auditing purposes. An example of a runtime identity context is the z/OS data area control block commonly known in the industry as the Accessor Environment Element or ACEE 120. Those familiar with the art will appreciate that this problem is not addressed by distributed approaches to similar appearing problems that are addressed by solutions involving federated identity servers and browser cookies.

Although “single-signon” products addressing some aspects of this problem exist, such as Tivoli Global Sign-On (offered by Tivoli Systems Inc., an International Business Machines Company), such products are based on a product specific “mapping file” that contains at some initial authentication server, a particular user's ID and password on some potential “target” server, platform or application. A current approach taken by these “single-signon” products is described below with reference to FIG. 2.

The system of FIG. 2 includes a distributed component 205 of a multi-component transaction processing environment 201 using a local user registry 206, a mainframe component 215 of a multi-component transaction processing environment using a local user registry 208, and a side file 219 containing user IDs and passwords for the mainframe component user registry. Similar to the example of FIG. 1, the distributed component and the mainframe component of the multi-component transaction processing environment are assumed to be built on different platforms, with disparate user registries 206, 208. A user 200 is identified and authenticated 210 at the distributed component using a corresponding user identity from user registry 206. Should a transaction 203 of distributed component 205 wish to forward a request 216 to the mainframe component 215, a user ID and password for the mainframe component 215 is obtained 218 from side file 219 and is included with the request 216. The mainframe component 215 then signs the user on like any other local request.

The application-owned mapping file approach described above leads to the following set of problems. First, mapping file entries are “target system based”, meaning that the caller of the service needs to know the target system(s). Also, the mapping file entry for a particular target platform, application, or middleware security service should contain an authenticator for the user in order to affect a “sign-on” for the user at the target unit. Usually the authenticator is the user's password, leading to administrative problems since passwords change from time to time, as well as to security concerns because the user's password would exist outside the protection offered by the local user registry such as one-way encryption of the password.

Those familiar with the art will further recognize that a password for the mainframe identity of the client end-user must be kept in a side file accessible to the distributed component of the transaction processing environment. Since the mainframe user's password must also be kept within the mainframe user registry, the password is in two locations. Such an arrangement is problematic for security reasons as well as operational reasons, in that if the user's password is changed in either of the locations, it must be changed in the other at the same time (which is often not possible) or authentication events will fail for events initiated during the period no matter how short when the two registries are out of sync. For this reason, and others, this arrangement is believed unacceptable for the multi-component transaction processing environment described above.

Further, since there are multiple single-signon products implementing similar functions in applications and middleware today, multiple different and non-compatible mapping file implementations exist which inhibit using disparate computing resources as an interoperable set. Moreover, the target platform, application, or middleware security service has no way of distinguishing a sign-on that comes to it from another platform, application, or middleware security service that has already accomplished the identification and authentication, from any other sign-on request be it local or remote. That is, from the perspective of the target platform, application, or middleware security service the “history” is lost. Still further, there is no general method or protocol for managing the security state of a transaction that is in transit. That is, once a request has been forwarded, and because the history is lost, there is currently no way to recognize that the request is the result of a specific earlier distributed request event so that the resulting request(s) can be easily stopped from being forwarded again and again, even though the user may have been revoked from the original, local user registry.

Taken together, these problems make distributed component applications that fan to multiple disparate mainframe components, or which multi-hop to multiple mainframe components, or combinations of these cases, unfeasibly problematic to implement using the approach of FIG. 2. This situation is a principle inhibitor to the development of distributed applications, which might otherwise be designed to exploit multi-platform, multi-component computing resources, as if the resources were a single interoperating set, especially from a security perspective.

One way to solve this problem is to force all applications and operating systems to share a common user registry. This approach may be viable in a homogenous environment, i.e., in a network that only has computers of the same platform type. However, implementing this approach on a heterogeneous network that includes several different components executing within several different operating systems would require that each operating system and each application be re-written to access some common user registry, rather than its local user registry. This is simply not a workable solution.

Prior to describing detailed embodiments of the present invention, the following definitions are presented for use herein:

Multi-component transaction processing environment: A transaction processing system or environment comprising distributed and mainframe components, working cooperatively to respond to for example HTTP and Web service client end-user service or transaction requests.

Distributed component: A component of a larger multi-component transaction processing environment comprising at least a computer, operating system platform, applications, networking and an associated security engine that provides distributed transaction processing functions such as networking interactions with the client end-user and identification and authentication functions in HTTP and Web services scenarios. Typically but not always, a distributed component will execute on an AIX, Windows or Linux OS platform. An example of a distributed component as defined here is the IBM WebSphere Application Server (WAS).

Mainframe component: A component of a larger multi-component transaction processing environment including at least a computer, operating system platform, applications, networking and associated security engine that provides high performance back-end transaction processing and large database functionality, in for example HTTP and Web services scenarios involving a distributed component as previously described.

Component trust domain: A set of transaction processing components that are coupled together via secure networking functions such as Secure Sockets Layer (SSL) or Virtual Private Networking (VPN), such that messages containing user identifications and other sensitive transaction data can flow between components while maintaining data confidentially and integrity.

Initial authentication component: A particular component within a component trust domain where a user first identifies and authenticates using the security services locally available to the component. Typically, this component is a distributed component of a multi-component transaction processing environment as previously described.

Subsequent processing component: A particular component within a component trust domain as previously defined, other than the initial authentication component, where additional, perhaps primary, processing of a client end-user's transaction request, occurs. Typically, this component is a mainframe component of a multi-component transaction processing environment as previously described.

Distributed security information: A collection of information that includes, but may not be limited to, the identity of the client end-user in distributed form (for example the client end-user's Windows Active Directory user identity), the distributed user security engine and registry where the client end-user is defined and by which the user was identified and authenticated (for example, the network name of the Windows Active Directory).

Authenticated identity propagation: A set of methods and services providing an infrastructure to support runtime client end-user identity cooperation between components of a multi-component transaction processing environment.

Enterprise Identity Mapping (EIM): A set of computing services that maintain and make available information detailing an enterprise user's individual identity names in multiple security user registries of multiple computer platforms, applications or middleware. The enterprise identity mapping (EIM), which is described in the above-identified U.S. Pat. No. 6,981,043, may be implemented on top of Lightweight Directory Access Protocol (LDAP). Note that EIM is separate from the concepts of the present invention, although in one embodiment of an environment using aspects of the present invention, the exploitation of EIM is facilitated, and the inclusion of EIM provides usability advantages in the solution presented.

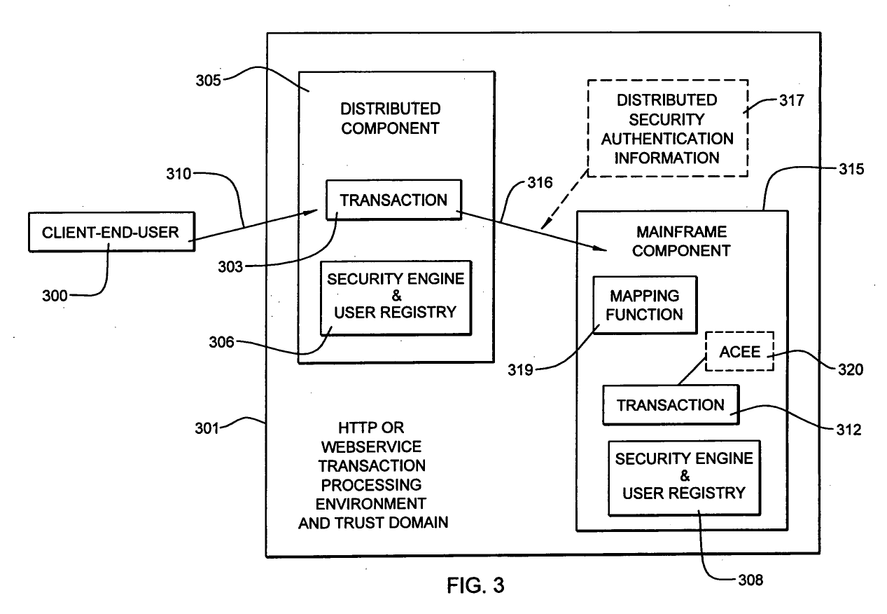

FIG. 3 shows one embodiment of a multi-component transaction processing environment 301 incorporating the present invention.

Referring to FIG. 3, the transaction processing environment 301 includes a distributed component 305 as an initial authentication component and a mainframe component 315 as a subsequent processing component. Each component 305, 315 includes its own security engine and user registry 306, 308. A user registry (also referred to herein as a local user registry or security registry) contains information on users having access to the respective component, such as user IDs and passwords. In one example, the initial authentication component 305 may be an instance of the IBM WebSphere Application Server (WAS), running on a Linux operating system running within a logical partition (LPAR) within an IBM System z (e.g., z9-109) computer, and the subsequent processing component 315 may be an instance of the IBM Customer Information Control System (CICS), running on an IBM z/OS operating system executing on the same or a different computer.

The initial authentication component 305 includes an identification and authentication component or service (not separately shown) to identify and authenticate a client end-user 300. In one embodiment, identification and authentication is accomplished by way of the operating system, for instance, implementing an appropriate pluggable authentication module in a Linux environment. In another embodiment, the client end-user identification and authentication is accomplished by client-authenticated SSL (Secure Sockets Layer) in which the client end-user 300 has a digital certificate signed by a certificate authority that is trusted by the authenticating distributed component 305.

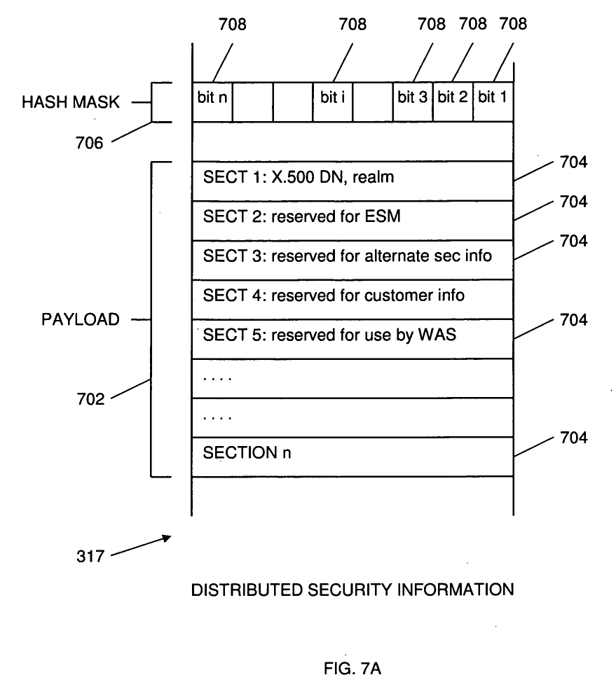

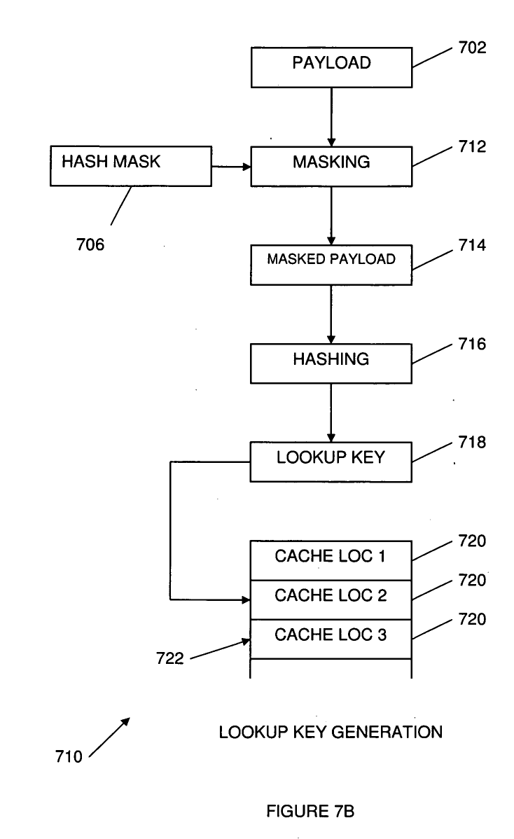

A trust relationship is established between the initial authentication component 305 and the security engine 308 of the subsequent processing component 315. The trust relationship is based on the secure exchange of a secret cryptographic data signature key that is used to validate distributed client end-user identities and other information transferred within the distributed security information transaction processing message part, as depicted in FIG. 7A and described below. The actual secure exchange is ancillary to the present invention, however, since multiple methods of accomplishing this are well documented in the art and in general use within the industry.

The initial authentication component 305 acquires a digital certificate as part of its installation processing, using for example the Simple Certificate Enrollment Protocol (SCEP), which is supported by the Public Key Infrastructure (PKI) function within the IBM z/OS operating system. As part of its initialization processing, the initial authentication component 305 establishes a client-authenticated SSL session with the security engine 308 of the mainframe component 315 of the transaction processing environment 301. During this “initialization session” the initial authentication component 305 will “register” itself as a user with the mainframe security engine 308 and have its credentials, including the shared secret data signature key, recorded within the user registry of the mainframe security engine (e.g., RACF) within the “key rings” that the mainframe security engine retains for selected users, thus establishing the trust relationship.

This trust relationship means that among security user identification and authentication services used by the distributed and mainframe components 305, 315, a user identification and authentication performed within one component is understood and trusted by another component within the multi-component transaction processing environment. This security trust relationship is also referred to herein as a trust domain, with domain formed by the components 305, 315 constituting the transaction processing environment 301 being one example. This trust domain is established to include initial authentication component 305 and at least one subsequent processing component 315.

In operation, a transaction 303 running within the distributed component 305 of the transaction processing environment 301, as part of its processing, initiates a subsequent transaction request 316 to the mainframe component 315 of the same environment to perform a subsequent transaction 312. Further and as described below, distributed component 305 includes distributed security information 317 in the transaction request message flow to mainframe component 315.

FIG. 7A shows the portions of the distributed security information 317 that are relevant to the present invention. As noted above, the distributed security information 317 typically forms a message part that is included in or appended to the subsequent transaction request 316 sent from the initial authentication component 305 to the subsequent processing component 315.

Referring to FIG. 7A, distributed security information 317 contains a security “payload” 702 divided into sections 704 (individually identified as sections 1 through n). Although sections 704 are shown in FIG. 7A as being contiguous and of equal size, in general they may be of arbitrary size and need not be contiguous with one another. In the embodiment shown, section 1 contains the name of the distributed client end-user, represented in X.500 (a well-known standard) distinguished name (DN) form, as well as the name of the realm (security domain) in which that user is defined, while sections 2 through 5 are likewise optional and are reserved for additional external security manager (ESM) information, alternate security information, customer information, and for use by WebSphere Application Server (WAS), respectively. However, the present invention is not limited to any particular number of payload sections 704 or to any particular defined uses for such sections.

Distributed security information 317 also contains a hash mask 706 composed of mask bits 708 (individually identified as bits 1-n) corresponding to payload sections 704, with each mask bit i controlling the use of the corresponding payload section i in generating a lookup key. More particularly, in the embodiment shown, if bit i of the hash mask 706 is a first value (e.g., one), then the corresponding section i of the payload 702 is included as part of the quantity that is hashed to form the lookup key, as described in more detail below. If, on the other hand, the corresponding mask bit i is a second value (e.g., zero), then the corresponding section i of the payload 702 is ignored when forming the hash. Such masked payload sections 704 are still available, however, for use by the subsequent processing component 315 for other purposes. This gives the end-user 300 a desirable flexibility in controlling the use of the various payload sections. The end user 300 may specify the hash mask 706 in any suitable manner, such as in the initial transaction request 310. Preferably, mask bits 1 and 2 are “on” (i.e, one) while the remaining mask bits are “off” (i.e., zero) by default.

In addition to the elements described above, distributed security information 317 may contain other elements not shown in FIG. 7A, such as those defining the size and position of the various sections 704 and a time stamp that is used as described in the above-identified patent application publication.

Mainframe component 315 receives the distributed security authentication information 317, along with the subsequent transaction request 316, and utilizes an administratively defined mapping function 319 to determine what local mainframe component user identity with which to execute the subsequent transaction 312. Note that the mapping function 319 utilized may be as simple as a programming coded table associating a given distributed client end-user with a specific mainframe user identity, or it may be a more administratively friendly and functional program product such as the IBM Enterprise Identity Mapping (EIM) or IBM RACF products. In either case, the actual mapping function employed is not unique to the present invention.

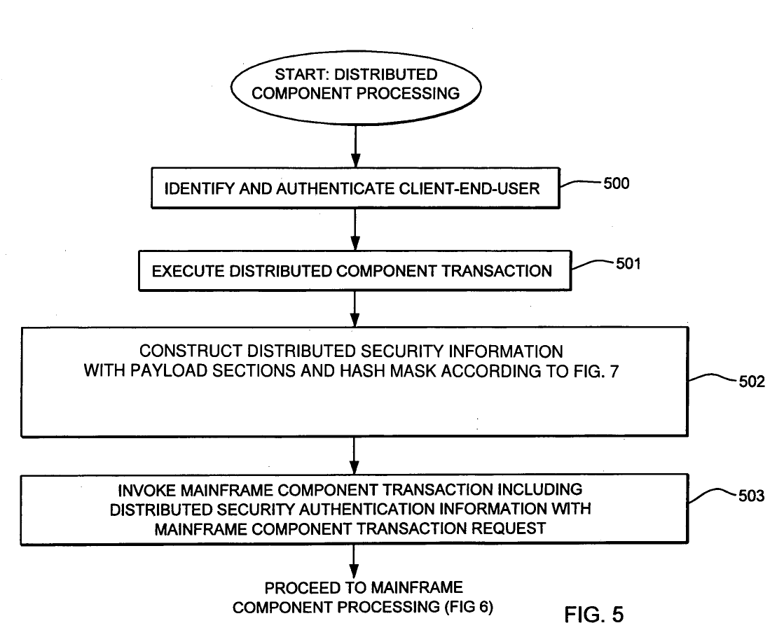

FIG. 5 shows the steps performed by the initial authentication component 305 that are relevant to the present invention.

Initially, a client end-user 300 invokes an HTTP or Web services request 310 to perform a transaction 303 within the initial authentication component 305 of the transaction processing environment 301. The user's credentials, e.g., user ID and password, are verified in the local user registry 306, and if accepted, the user 300 is identified and authenticated by the initial authentication component 305 (step 500). In one example, identification and authentication could be accomplished over a 128-bit SSL connection between the user 300 and the initial authentication component 305. In another example, the user 300 could be identified and authenticated using Kerberos (i.e., a network authentication protocol available from Massachusetts Institute of Technology).

The initial authentication component 305 could be running on a UNIX-based operating system, and have a pluggable authentication module (PAM) interface. In such an embodiment, an application or middleware layer of the component 305 could invoke the PAM interface to authenticate the user 300. In another embodiment, the application or middleware could invoke any conventional built-in identification and authentication technology to authenticate the user 300.

Once identification and authentication has been achieved employing the client end-user's distributed identity and realm (registry and security engine where the client end-user is known and authenticated), the transaction component 303 that is performed on the initial authentication component 305 is executed (step 501). Along with any other processing that the initial authentication component 305 may contribute to the completion of the overall request 310, the initial authentication component determines whether any mainframe components of the transaction are required to complete the request. If not, the transaction is complete.

If the initial authentication component 305 determines that a mainframe transaction component 312 is required to complete the request 310, the initial authentication component invokes a request 316 (step 502) to the subsequent processing component 315 for it to execute the mainframe transaction component, and includes with the request the distributed security information 317. The initial authentication component then sends the transaction request message 316 with the appended distributed security information 317 (step 503) via secure message protocol to the subsequent processing component 315.

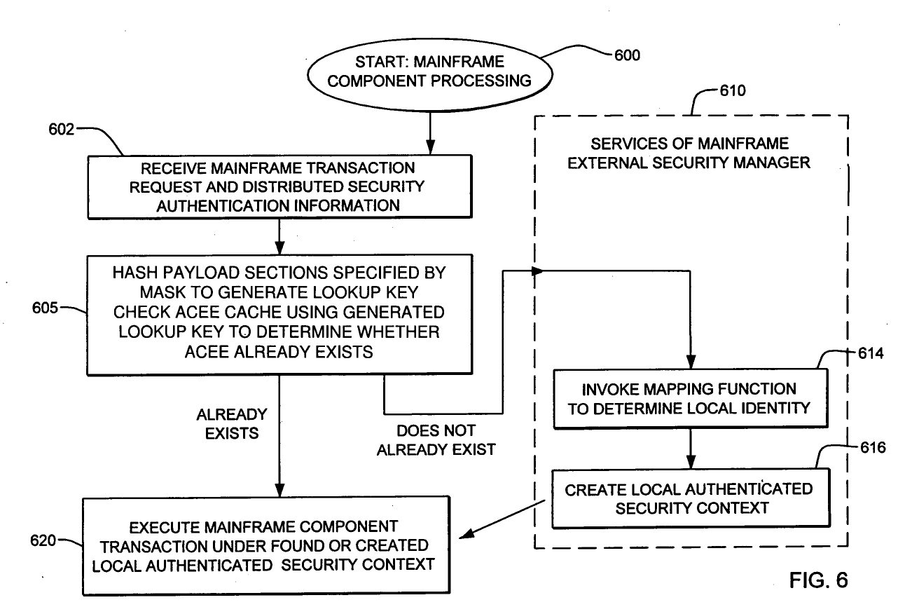

FIG. 6 shows the operation 600 of the subsequent processing component 315 that is relevant to the present invention.

As shown in FIG. 6, upon receiving the transaction request message 316 (step 602), the mainframe component 315 uses the distributed security information 317 to generate a lookup key within its local cache of runtime security contexts, e.g. RACF ACEE, to see if it has already processed and retained in its cache a copy of the runtime security context. More particularly, mainframe component 315 generates a hash of the payload sections 704 specified by mask 706 to generate a lookup key and checks the ACEE cache using the generated lookup key to determine whether the ACEE already exists (step 605).

FIG. 7B shows the key generation logic 710 that is used by the subsequent processing component 315 to generate the lookup key in step 605. Key generation logic 710 may be implemented in software, hardware or a combination of the two.

As shown in FIG. 7B, in key generation logic 710, the payload 702 from the distributed security information 317 is supplied along with the hash mask 706 to suitable masking logic 712 to produce a masked version 714 of the payload 702. As noted above, this is preferably performed by having each bit 708 of the hash mask 706 control the masking of a corresponding section 704 of the payload 702, such that the payload section 704 is reproduced in the masked version 714 in its original form if the corresponding masking bit is one, but with the payload section bits set to zero (or omitted) if the corresponding masking bit 708 is zero.

This masked version 714 of the original payload 702 is then supplied as an input to hashing logic 716 to produce a lookup key 718, which is used to access an ACEE 320 in a corresponding location 720 in an ACEE cache 722. Although the hashing logic 716 may perform a cryptographic hash using a secret key (as described in the above-identified patent application publication), this is not necessary, and in a preferred embodiment a non-cryptographic hash is used.

If at step 605 it is determined that an ACEE 320 already exists in location 720 (i.e., a valid context exists in the local cache 722 as confirmed by a synonym check, which eliminates the possibility of a hash collision), the subsequent processing component 315 associates the context with the thread of execution assigned to this particular transaction processing request 316 and executes the transaction 312 (step 620).

If, on the other hand, a valid context 720 is not found in the local cache 722 at step 605 using the generated hash 718 as the lookup key, the subsequent processing component 315 invokes the services of a mainframe external security manager (ESM), e.g. RACF, to invoke a mapping function 319 (step 614) (for example EIM or an existing RACF mapping function such as RACF Certificate Name Filtering) to determine the appropriate mainframe user identity for the execution of the transaction 312; mapping function 319 then creates (step 616) the runtime authenticated user identity security context 320, which is returned to the subsequent processing component 315, where the context is associated with the execution thread assigned to the processing of the transaction 312, placed in the cache 722 using the hash 718 as the lookup key, and the transaction is executed at step 620. As already noted above, an example of a z/OS mainframe transaction processing application is the IBM Customer Information Control System (CICS).

The requested transaction 312 within the mainframe component 315 is executed at step 620 under (i.e., in association with) the appropriate local identity as represented by the runtime security context 320 that has been associated with the thread of execution of the transaction, as described, and any audit records created during the execution of the transaction or its invocation will include the distributed security information as well as the local identity used.

From FIGS. 6 and 7B, it can be seen that a local cache 722 of ACEEs 320 can be kept for a reasonable period of time by the mainframe component 315. This cache 722 is anchored using the hash 718 of the payload 702, which describes, for security purposes, the particular client end-user 300. Those skilled in the art will recognize that the term “anchor” refers to the lookup key used to find a particular entry in a multi-entry cache of logical items. In this manner both multiple identity mappings and multiple ACEE creations are avoided for the same client end-user submitting multiple transaction requests within the same relatively short interval of time.

Those familiar with the art will appreciate that the process described herein, when practiced within an environment as described or a similar environment, will securely accomplish the objectives of identity propagation and translation, as described, with a minimum of additional computer processing overhead such as machine cycles and use of system memory and storage.

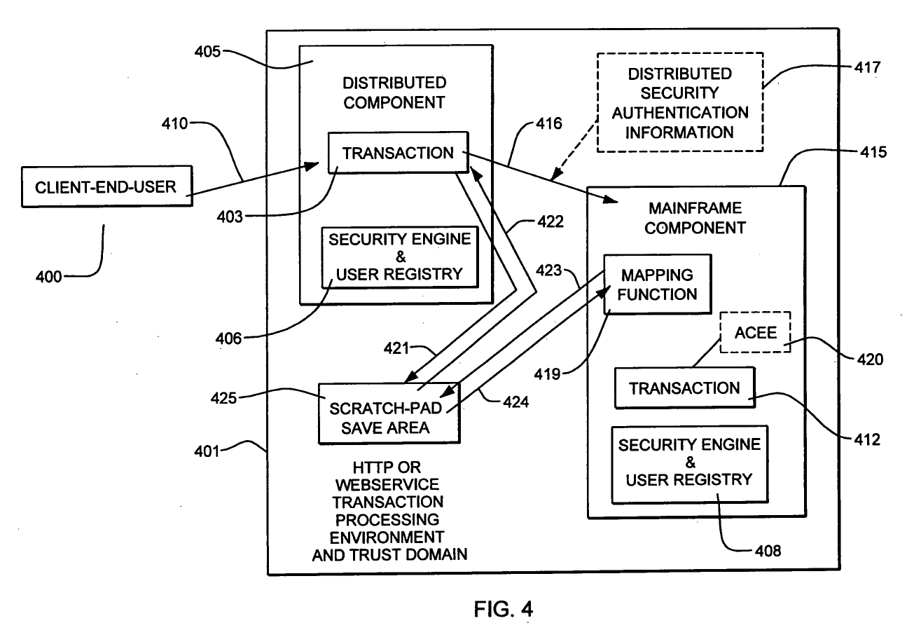

FIG. 4 depicts another embodiment of the present invention, wherein the communication protocol 416, which is used to transmit the request of the distributed component of the multi-component transaction processing environment 401 for execution of a particular transaction 412 within the mainframe component 415, is insufficient in bandwidth to contain the distributed security information. Note that FIGS. 4 and 3 are almost identical with the exception of the depiction of the scratch-pad area 425 and the flows to and from the scratch-pad area 421 through 424. With the exception of these items and the description of the distributed security information 417 which will be described next, the remaining items are identical in meaning and function with those of FIG. 3 of similar number (minus 100). Stated another way, with the stated exceptions, the items on FIG. 4 that are enumerated with the reference number 4xy are identical to meaning and function as items on FIG. 3 enumerated with the reference numbers 3xy, where x and y are identical digits between the figures.

As stated above, FIG. 4 depicts an example where the messaging protocol used in flow 416 has insufficient bandwidth to contain the distributed security information. In this case, transaction 403 invokes 421 the scratch-pad area 425 to temporarily store the distributed security information. The scratch-pad area function returns an address within the scratch-pad area, referred to herein as a “token”, that is small in size compared with the whole of the distributed security information, so that it can flow with the transaction request 416 in representation of the distributed security information 417.

As a further aspect of the present invention, the mainframe component 415 of the multi-component transaction processing environment 408, upon receiving the processing request 416, invokes 423 the scratch-pad area function 425 passing it the distributed security information token 417 received in the request. The scratch-pad area function then returns 424 the complete distributed security information, and processing continues as depicted in FIG. 3.

To summarize, described above are various examples of authenticated identity propagation and translation in accordance with the present invention. An authenticated identity propagation and translation method is provided. The various techniques described herein are applicable to single physical computing systems, homogeneous systems, as well as heterogeneous systems.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the art that various modifications, additions, subtractions, substitutions and the like can be made without departing from the spirit of the invention and these are therefore considered to be within the scope of the invention as defined in the following claims.

What is claimed is:

1. An authenticated identity propagation and translation method for use in a transaction processing environment containing an initial authentication component and a subsequent processing component, the method comprising, at the initial authentication component, responsive to a transaction request initiated by an authenticated client end-user requiring further transaction processing at the subsequent processing component:
generating a further transaction request together with distributed security information, the distributed security information containing a plurality of sections with identifying information about an authenticated client end-user identity as known at the initial authentication component and a mask specifying a subset of the sections; and
transmitting the further transaction request and the distributed security information to the subsequent processing component.

2. The method of claim 1, further comprising, at the subsequent processing component, responsive to receiving the further transaction request from the initial authentication component:
generating a lookup key from the subset of the sections of the distributed security information specified by the mask; and
using the generated lookup key to determine whether a local authenticated runtime security context already exists in a local cache for the client end-user initiating the transaction request.

3. The method of claim 2 in which the step of generating a lookup key comprises generating a hash from the subset of the sections of the distributed security information specified by the mask.

4. The method of claim 2, further comprising, at the subsequent processing component:
if a local authenticated runtime security context already exists for the client end-user initiating the transaction request, employing the existing local authenticated runtime security context in executing the further transaction request; and
if a local authenticated runtime security context does not already exist for the client end-user initiating the transaction request, mapping the authenticated client end-user identity of the client end-user at the initial authentication component to a local identity employing the distributed security information and creating a local authenticated runtime security context representative of the local mainframe identity and the authenticated client end-user identity for execution of the further transaction request.

5. The method of claim 4, further comprising:
storing the created local authenticated runtime security context at a location specified by the lookup key.

6. A computer program product stored on a tangible computer-usable medium, comprising a computer-readable program for causing a computer to perform the method steps of claim 1 when the program is run on the computer.

7. An authenticated identity propagation and translation method for use in a transaction processing environment containing an initial authentication component and a subsequent processing component, the method being performed at the subsequent processing unit and comprising:
receiving a transaction request from the initial authentication component together with distributed security information, the distributed security information containing a plurality of sections with identifying information about an authenticated client end-user identity as known at the initial authentication component and a mask specifying a subset of the sections; and
responsive to receiving the further transaction request from the initial authentication component, generating a lookup key from the subset of the sections of the distributed security information specified by the mask and using the generated lookup key to determine whether a local authenticated runtime security context already exists in a local cache for the client end-user initiating the transaction request.

8. The method of claim 7 in which the step of generating a lookup key comprises generating a hash from the subset of the sections of the distributed security information specified by the mask.

9. The method of claim 7, further comprising:
if a local authenticated runtime security context already exists for the client end-user initiating the transaction request, employing the existing local authenticated runtime security context in executing the further transaction request; and
if a local authenticated runtime security context does not already exist for the client end-user initiating the transaction request, mapping the authenticated client end-user identity of the client end-user at the initial authentication component to a local identity employing the distributed security information and creating a local authenticated runtime security context representative of the local mainframe identity and the authenticated client end-user identity for execution of the further transaction request.

10. The method of claim 9, further comprising:
storing the created local authenticated runtime security context at a location specified by the lookup key.

11. A computer program product stored on a tangible computer-usable medium, comprising a computer-readable program for causing a computer to perform the method steps of claim 7 when the program is run on the computer.

12. An authenticated identity propagation and translation system for use in a transaction processing environment containing an initial authentication component and a subsequent processing component, the system comprising:
means at the initial authentication component, responsive to a transaction request initiated by an authenticated client end-user requiring further transaction processing at the subsequent processing component, for generating a further transaction request together with distributed security information, the distributed security information containing a plurality of sections with identifying information about an authenticated client end-user identity as known at the initial authentication component and a mask specifying a subset of the sections; and
transmitting the further transaction request and the distributed security information to the subsequent processing component.

13. The system of claim 12, further comprising:
means at the subsequent processing component, responsive to receiving the further transaction request from the initial authentication component for generating a lookup key from the subset of the sections of the distributed security information specified by the mask and for using the generated lookup key to determine whether a local authenticated runtime security context already exists in a local cache for the client end-user initiating the transaction request.

14. The system of claim 12 in which the means for generating a lookup key generates a hash from the subset of the sections of the distributed security information specified by the mask.

15. The system of claim 12, further comprising:
means responsive to the existence of a local authenticated runtime security context for the client end-user initiating the transaction request for employing the existing local authenticated runtime security context in executing the further transaction request; and
means responsive to the non-existence of a local authenticated runtime security context for the client end-user initiating the transaction request at the initial authentication component for mapping the authenticated client end-user identity of the client end-user at the initial authentication component to a local identity employing the distributed security information and for creating a local authenticated runtime security context representative of the local mainframe identity and the authenticated client end-user identity for execution of the further transaction request.

16. The system of claim 15, further comprising:
means for storing the created local authenticated runtime security context at a location specified by the lookup key.

17. An authenticated identity propagation and translation system for use in a transaction processing environment containing an initial authentication component and a subsequent processing component, the system being associated with the subsequent processing unit and comprising:
means for receiving a transaction request from the initial authentication component together with distributed security information, the distributed security information containing a plurality of sections with identifying information about an authenticated client end-user identity as known at the initial authentication component and a mask specifying a subset of the sections; and
means responsive to receiving the transaction request from the initial authentication component for generating a lookup key from the subset of the sections of the distributed security information specified by the mask and for using the generated lookup key to determine whether a local authenticated runtime security context already exists in a local cache for the client end-user initiating the transaction request.

18. The system of claim 17 in which the means for generating a lookup key generates a hash from the subset of the sections of the distributed security information specified by the mask.

19. The system of claim 17, further comprising:
means responsive to the existence of a local authenticated runtime security context for the client end-user initiating the transaction request for employing the local authenticated runtime security context in executing the transaction request; and
means responsive to the non-existence of a local authenticated runtime security context for the client end-user initiating the transaction request for mapping the authenticated client end-user identity of the client end-user at the initial authentication component to a local identity employing the distributed security information and for creating a local authenticated runtime security context representative of the local identity and the authenticated client end-user identity for execution of the transaction request.

20. The system of claim 19, further comprising:
means for storing the created local authenticated runtime security context at a location specified by the lookup key.
